(19) United States
(12) Patent Application Publication
(10) Pub. No.: US 2012/0136757 A1
(43) Pub. Date: May 31, 2012

(54) Methods and Systems for Operating a Virtual World

(76) Inventors: Taranbir Singh Chopra, La Canada Flintridge, CA (US); Rajeev Kumar Aggarwal, Palos Verdes Estates, CA (US); Wardell C. Townsend, Silver Spring, MD (US)

(21) Appl. No.: 13/198,865

(22) Filed: Aug. 5, 2011

Related U.S. Application Data
(63) Continuation of application No. 13/108,190, filed on May 16, 2011.
(60) Provisional application No. 61/417,333, filed on Nov. 26, 2010.

(51) Int. Cl. G06F 3/048; G06Q 30/00; G06Q 40/00; G06F 15/16

(52) U.S. Cl. 705/27.2; 715/757; 705/39

(57) ABSTRACT

A virtual world is operated by an automated system, in which choices available to be made by avatars are assigned point values. As an avatar makes a choice, a corresponding point values is tabulated by the automated system in a record specific to that avatar, and an updated points total for the avatar is processed against predetermined definitions defined in quantitative terms for underlying qualitative concepts such as unhealthiness, non-renewable energy usage, wastefulness, etc. The automated system performs steps as a function of the avatar's points total, such as changing the avatar's appearance such as body weight representation, causing the avatar to have a heart attack, etc.

### RELATED APPLICATION

This claims benefit of U.S. provisional patent application No. 61/417,333 filed Nov. 26, 2010 by Chopra, Aggarwal and Townsend.

### FIELD OF THE INVENTION

This invention relates to the Internet, more particularly to on-line virtual worlds useable by multiple users via an avatar of each user.

### BACKGROUND OF THE INVENTION

Thus far, there have been some virtual worlds and Internet-based games on the Internet.

For a website on the Internet being operated by an entrepreneur, number of visitors and time spent by each visitor on the website are important parameters. One way that the “stickiness” to a website is increased is through use of creative applications that are entertaining and have a broad appeal to most audiences. Conversely, a virtual world that fails to entertain, or otherwise appeal to, users will be unlikely to develop a base of users. Various technologies have been proposed in the patent literature for virtual worlds, with some examples being:

US 2008/0070690 published Mar. 20, 2008 by van Luchene et al., for “Credit cards in a virtual environment.”

U.S. Pat. No. 7,775,885 issued Aug. 17, 2010 to Van Luchene et al., for “Event-driven alteration of avatars”.

US 2010/0211892 published Aug. 19, 2010 by Fujioka, for “Widgetized avatar . . . ”.

U.S. Pat. No. 7,792,801 issued Sep. 7, 2010 to Hamilton, II et al., for “Controlling and using virtual universe wish lists.”

U.S. Pat. No. 7,797,168 issued Sep. 14, 2010 to Kusumoto et al., for “System and method for consumer-selected advertising and branding in interactive media.”

U.S. Pat. No. 7,818,183 issued Oct. 19, 2010 to Schoenberg, for “Connecting consumers with service providers.”

U.S. Pat. No. 7,824,253 issued Nov. 2, 2010 to Thompson et al., for “System and method for providing real world value in a virtual world environment.”

### SUMMARY OF THE INVENTION

The invention, in a first preferred embodiment, provides a method of operating a virtual world useable simultaneously by a plurality of users, each user controlling a respective avatar generated by a system operating the virtual world, comprising steps, performed by a computing device, of: for each avatar, maintaining at least one updatable unhealthfulness record that is expressed as a quantity, the unhealthfulness record being maintained privately by the system without display to the user associated with the avatar; maintaining a table including at least one avatar activity that can be done by an avatar, each avatar activity in the table having a predefined change to be made to the quantity upon the activity being performed by the avatar; updating the unhealthfulness record as a function of activity by the avatar, according to the table, to a current quantity; comparing the current quantity to a certain predefined value that is a restriction condition; and if the current quantity has reached the restriction condition, imposing on the avatar a heart attack or other negative medical event, and/or other negative consequence, such as, e.g., inventive methods that include receiving an initial indication of body weight from a user that characterizes the avatar controlled by the user; maintaining a body weight value for the avatar as an updatable record; and tracking activity of the avatar and updating the updatable body weight value for the avatar based on activity of the avatar; and other inventive methods.

In another preferred embodiment, the invention provides a method of operating a virtual world useable simultaneously by a plurality of users, each user controlling a respective avatar, comprising steps, performed by a computing device, of: (A) maintaining a table comprising at least one restriction condition, wherein each restriction condition is expressed in terms of a quantity and the quantity is tabulated by the system as a function of one or more activities in which the avatar has engaged and which are defined by the system as, when performed by an avatar, having a certain predefined contribution to the quantity being tabulated for a certain restriction condition; (B) for an avatar who has engaged in activity that is linked to a certain restriction condition, computing a record for the avatar that is a computed quantity which computed quantity is comparable to the quantity of the restriction condition, and screening for whether an avatar has reached the restriction condition; (C) for an avatar that has met the restriction condition, restricting the avatar according to a restriction, wherein the restriction is selected from the group consisting of: excluding the avatar from accessing certain parts of the virtual world; changing size, changing shape, or otherwise changing an appearance of the avatar with the appearance-change being only updatable by the system operating the virtual world not by the user associated with the avatar; imposing a slow-down on the avatar or otherwise changing a capability of the avatar in a negative direction with the capability-change being only updatable by the system operating the virtual world not by the user associated with the avatar; subjecting the avatar to a heart attack or other negative health event; and combinations thereof, such as, e.g., inventive methods that include storing for each avatar an updatable record for each restriction condition that indicates a quantity attributed to the avatar that is comparable to the quantity of the restriction condition; inventive methods wherein an avatar has a current appearance, and upon the avatar being found to have met a certain defined restriction condition, the system operating the virtual world alters the current appearance to a changed appearance; inventive methods that include: receiving an initial indication of body weight from a user for characterizing the avatar controlled by the user; maintaining a body weight value for the avatar as an updatable record; and tracking activity of the avatar and updating the updatable body weight value for the avatar based on activity of the avatar; inventive methods that include receiving a real-world photograph from the user to be associated with the avatar in the virtual world; inventive methods that include meanwhile permitting the user to manipulate certain features of the appearance of the avatar, while blocking the user from undoing any restriction condition that is in force to the user's avatar; inventive methods that include giving the user access to manipulate clothing and hairstyle appearance of the avatar, but meanwhile maintaining size, shape and health-related appearance of the avatar as non-manipulable by the user; and other inventive methods.

In another preferred embodiment, the invention provides a method of operating a virtual world, comprising steps, performed by a computing device, of: operating in the virtual world at least one virtual business which offers for purchase at least one purchasable product or service that is offered for purchase by an avatar in the virtual world and that when purchased by an avatar in the virtual world is delivered in the real world; such as, e.g., inventive methods that include receiving a virtual-world purchase instruction as submitted by an avatar, and processing the purchase instruction to cause delivery of the purchased good or service in the real-world to the real-world user represented by the avatar or to a real-world recipient designated by the avatar; inventive methods that include receiving a real-world credit card authorization at an initial time substantially in advance of the virtual-world purchase instruction, and associating the real-world credit card authorization with the avatar (such as, e.g., receiving a credit limit instruction to be enforced for the avatar when the avatar subsequently submits a purchase instruction); and other inventive methods.

The invention in another preferred embodiment provides a method of receiving and filling purchase orders, comprising steps, performed by a computing device, of: constructing a virtual world including at least one virtual business which offers for purchase at least one purchasable product or service that is offered for purchase by an avatar in the virtual world and that when purchased by an avatar in the virtual world is delivered outside the virtual world, in a real world delivery; and via the virtual business, receiving a purchase order by an avatar; and processing the avatar's purchase order and causing the real world delivery, such as, e.g., inventive methods that include causing the real-world shipment and delivery of real-world goods; inventive methods that include causing the real-world provision of real-world services; and other inventive methods.

Another preferred inventive embodiment provides a method of receiving and filling purchase orders, comprising steps, performed by a computing device, of: operating a virtual world including at least one virtual business which offers for purchase at least one purchasable product or service that is offered for purchase by an avatar in the virtual world and that when purchased by an avatar in the virtual world is delivered outside the virtual world, in a real world delivery; and via the virtual business, receiving a purchase order by an avatar; and before filling the purchase order by the avatar, screening for a health status or other non-financial status of the avatar in records maintained by the system based on the avatar's activity in the virtual world; such as, e.g., inventive methods that include denying the avatar purchasing privileges as a function of the avatar having met a certain restriction condition, the certain restriction condition being non-financial; inventive methods that include denial of purchasing privileges to an avatar who had a recent heart attack or other health problem in the virtual world; inventive methods that include, after screening the health status or other non-financial status of the avatar, rewarding the avatar with a real-world discount or other reward having real-world value; and other inventive methods.

The invention in another preferred embodiment provides a method of operating a virtual world, comprising steps, performed by a computing device, of: issuing a credit card to an avatar with a certain credit limit, wherein the credit card is useable by the avatar to accomplish a real-world transaction.

In another preferred embodiment, the invention provides a method of operating a virtual world useable simultaneously by a plurality of users, each user controlling a respective avatar, comprising steps, performed by a computing device, of: maintaining a table comprising at least one restriction condition, wherein each restriction condition is expressed in terms of a quantity and the quantity is tabulated by the system as a function of one or more activities in which the avatar has engaged and which are defined by the system as, when performed by an avatar, having a certain predefined contribution to the quantity being tabulated for a certain restriction condition; for each avatar, maintaining an updatable record for each restriction condition; for at least one activity in which avatars may engage and which is linked to a restriction condition, tracking whether an avatar engaged in that activity, and if so, updating the updatable record for the avatar; screening for whether an avatar has met a certain restriction condition; and for an avatar that has met the certain restriction condition, restricting the avatar according to a restriction for the certain restriction condition, such as, e.g., inventive methods in which the restriction condition is selected from the group consisting of: a condition that is a definition of an avatar controlled by the user having engaged in an unhealthy consumption of food or alcohol, and upon finding that a user has met the condition, performing a restriction for the user; an anti-obesity condition that is a definition of an avatar controlled by the user in the virtual world consuming more than a certain amount of calories within a certain period of time; a Driving While Intoxicated (“DWI”) condition that is a definition of an avatar controlled by a user in the virtual world attempting to operate a vehicle after having consumed more than a certain quantity of alcohol within a certain recent time period; inventive methods that include storing for each avatar an updatable record for each restriction condition that indicates a quantity attributed to the avatar that is comparable to the quantity of the restriction condition; inventive methods wherein an avatar has a current appearance, and upon the avatar being found to have met a certain defined restriction condition, the system operating the virtual world alters the current appearance to a changed appearance; inventive methods that include receiving an initial indication of body weight from a user for characterizing the avatar controlled by the user; maintaining a body weight value for the avatar as an updatable record; and tracking activity of the avatar and updating the updatable body weight value for the avatar based on activity of the avatar; inventive methods including meanwhile permitting the user to manipulate certain features of the appearance of the avatar; and other inventive methods.

The invention in another preferred embodiment provides a method of operating a virtual world useable simultaneously by a plurality of users, comprising steps, performed by a computing device, of: permitting at least one user to have access to a part of the virtual world having an underlying opportunity for the user to be awarded a Virtual Reward; processing activity by the user in the virtual world for whether a condition for the user to be awarded the Virtual Reward has been met, and, upon the condition to be awarded the Virtual Reward being found to have been met by the user, awarding the Virtual Reward to the user who met the condition; maintaining a table in which, for the Virtual Reward that is awardable in the virtual world, a corresponding Tangible Reward, if any, is linked thereto; and after the Virtual Reward has been awarded to the user, if the Virtual Reward is linked to a Tangible Reward, communicating to the user instructions information describing how the user can take possession of the Tangible Reward; such as, e.g., inventive methods wherein a description of a certain Virtual Reward and/or of the Tangible Reward associated therewith is not communicated to the user in advance of the user being awarded the Virtual Reward; inventive methods a description of what activity is required by the user to be awarded the Virtual Reward is not explicitly communicated to the user by the system operating the virtual world in advance of the user being awarded the Virtual Reward; inventive methods wherein the virtual world includes a virtual presence associated with a trademark, wherein the virtual presence has been authorized by an owner of the trademark, and wherein the method includes in-taking from the trademark owner or an authorized party (1) a machine-readable definition of a condition to met to award a Virtual Reward that relates to the trademark and (2) a machine-readable definition of a Tangible Reward to be associated with the Virtual Reward; inventive methods receiving payment from a trademark owner or other business customer in connection with a package of a Virtual Reward and an associated Tangible Reward being operated for a certain time period in the virtual world; and other inventive methods.

The invention in another preferred embodiment provides a method of operating a virtual world, comprising steps, performed by a computing device, of: processing a transaction by an avatar in which the avatar requests a virtual loan from another avatar.

Also the invention in another preferred embodiment provides a method of operating a virtual world, comprising steps, performed by a computing device, of: receiving a vouching-for assistance a first avatar and/or by a vouching user associated with a first avatar, in which the vouching user vouches for a second avatar associated with a different user; and during a time period of the vouching, for activity by the second avatar that gives rise to accumulation of any disadvantage points towards a restriction condition, accessing the points against the first avatar or otherwise making an unfavorable update of a record of the first avatar; such as, e.g., inventive methods wherein the vouching is for a time selected from the group consisting of: a fixed number of the next hours of play by the second avatar; a time as measured by real-world time; an open-ended time until a certain threshold is met by the second avatar such that the vouching expires; and other inventive methods.

### BRIEF DESCRIPTION OF THE DRAWINGS

The invention may be appreciated with reference to the attached figures, without the invention being limited thereto:

FIG. 1 is an exemplary flow chart of inventive steps performed by an automated system operating a virtual world, for an avatar An that has access to the virtual world.

FIG. 2 is an example of a inventive table 200 that may be used for practicing the inventive updating step 102 in FIG. 1.

FIG. 3 is an example of a sample screen 300 from an inventive virtual world in which an avatar is offered optional consumption choices which are tabled in a table 200 of FIG. 2.

FIG. 4 is an exemplary flow chart that may be used by an automated system operating a virtual world in connection with a comparing step 104 in FIG. 1.

FIG. 5 is an example of a sample screen 500, later in time than FIG. 3, corresponding to an inventive automated system practicing an exemplary inventive imposing step 412 of FIG. 4.

### DETAILED DESCRIPTION OF A PREFERRED EMBODIMENT OF THE INVENTION

The invention in a preferred embodiment provides the methods of operating a virtual world, with the method steps being performed by computers, processors, or other machines. Preferably the steps of the inventive methods are performed by an automated system comprising one or more processors, computers or other machines that perform the method steps. Inventive methods preferably include permitting at least one user (preferably multiple users) to have access to the virtual world wherein the user in the form of an avatar controlled by the user navigates the virtual world. Preferably, the virtual world is useable simultaneously by a plurality of users with each user having an avatar.

We believe that we are using terms according to their common usage regarding Internet websites and virtual worlds.

When we refer herein to an “avatar”, we mean the on-screen visual image that is controlled by a “user” and that can engage in virtual activities in a virtual world. An avatar optionally may have a voice.

When we refer herein to “restriction”, we mean the processing of the automated system that operates the virtual world that can be executed against a particular avatar which is intended to be considered undesirable or restrictive by the user operating the avatar. Examples of a “restriction” are, e.g., excluding the avatar from accessing certain parts of the virtual world; changing the appearance of an avatar with the appearance-change being only updatable by the system operating the virtual world not by the user associated with the avatar; changing a capability of the avatar in a negative direction with the capability-change being only updatable by the system operating the virtual world not by the user associated with the avatar; subjecting the avatar to a heart attack or other negative health event; involuntary logging-off the avatar and the user associated therewith; blocking the user associated with the avatar from logging-in; and combinations thereof.

When we refer herein to a “restriction condition”, we refer to possible activity by an avatar that is susceptible to a definition in quantitative team and that is computed and updated by a processor or computing device, for whether the avatar's activity has reached a numerical value at which a restriction of the avatar's activity will be imposed by the automated system. Preferably a restriction condition, which is a quantitative definition, is defined in connection with a qualitative value or principle (such as, e.g., a qualitative value regarding unhealthy food consumption; a qualitative value regarding consumption of non-renewal energy; etc.) underlying the virtual world available to the avatars. Examples of a restriction condition are, e.g., a restriction condition that is a definition of an avatar controlled by the user having engaged in an unhealthy consumption of food or alcohol, and upon finding that a user has met the condition, performing a restriction for the user; an anti-obesity restriction condition that is a definition of an avatar controlled by the user in the virtual world consuming more than a certain amount of calories within a certain period of time; a DWI restriction condition that is a definition of an avatar controlled by a user in the virtual world attempting to operate a vehicle after having consumed more than a certain quantity of alcohol within a certain recent time period; etc. When we refer herein to a “user”, we mean a human such as a human who is controlling an avatar.

When we refer herein to a “visitor” or “visitors”, such as a visitor to a cyber-resort, we mean an avatar. Below where we refer to “visitors”, we also mean a “visitor” singly, namely, that multiple visitors each visitor operated by a respective user may be using the virtual world.

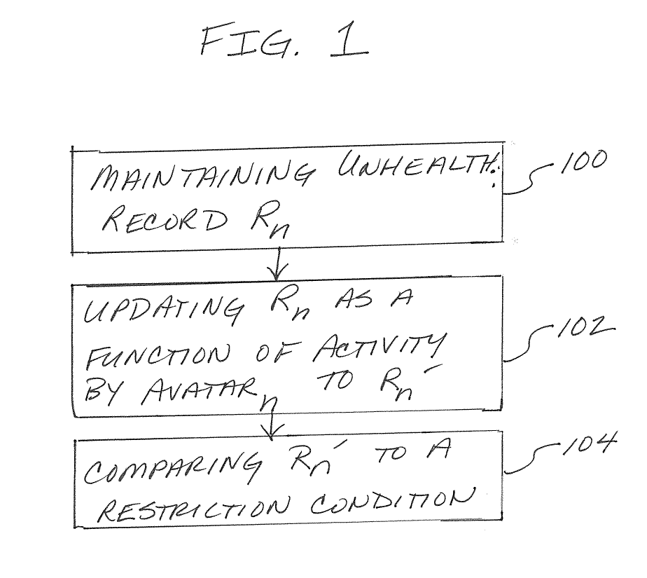

Referring to FIG. 1, the invention may be practiced by an automated system, for an Avatar An where “n” uniquely designates one of a plurality of avatars in a virtual world, maintaining (100) an unhealthfulness record Rn for the Avatar An; updating (102) the unhealthfulness record Rn wherein the updating is done as a function of activity by the Avatar An and the updated record is R′n; and comparing (104) the updated record Rn′ to a restriction condition. The unhealthfulness record Rn is expressed as a quantity that can be processed (such as, e.g., increased, decreased, and compared to another quantity) by an automated system. Preferably the unhealthfulness record Rn is maintained privately by the automated system without display of the record Rn to the user n associated with the Avatar An.

In one embodiment, points are added to the unhealthfulness record for healthy choices by the avatar, so that a high positive points score represents health. In another embodiment, points are subtracted from the unhealthfulness record for unhealthy choices by the avatar, so that a lower score represents worse health. Choices by avatar An are used to update the corresponding unhealthfulness record Rn for that avatar An. That is, in a system with two avatars, A1 and A2, the unhealthfulness record R1 for avatar A1 is updated based on Avatar A1's choices, and the unhealthfulness record R2 for avatar A2 is updated based on Avatar A2's choices.

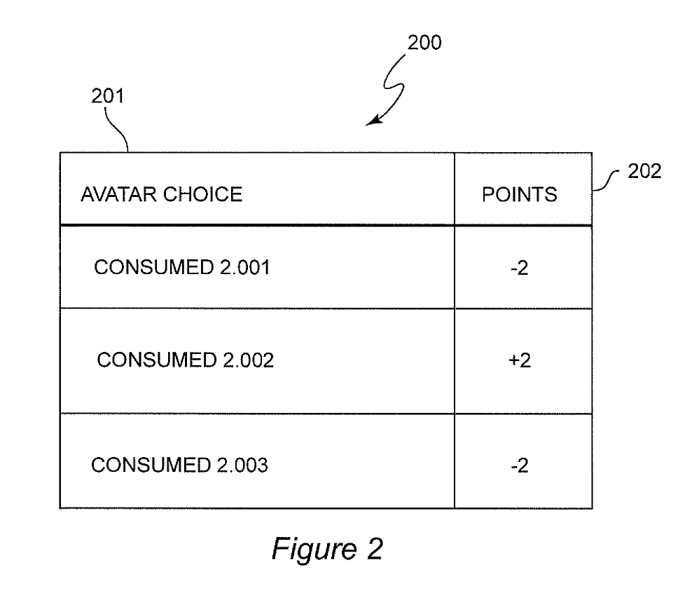

The updating of the respective unhealthfulness records for the universe of avatars A1 . . . An is done based on a table, such as table 200 in FIG. 2. Table 200 (FIG. 2) is an illustration, in which each avatar choice 201 has a corresponding point value 202, such as an avatar choice 201 of “consumed 2.001” (such as “consumed soda” or “consumed non-renewable energy”) corresponds to a points value of −2; an avatar choice 201 of “consumed 2.002” (such as “consumed organic fruit smoothy”) corresponds to a points value of +2; and an avatar choice 201 of “consumed 2.003” (such as “consumed hamburger”) corresponds to a points value of −2. If and when an avatar An performs one of the activities that are tabled as avatar choices 201 in the table 200, the automated system uses the points value 202 from the table 200 to update the record Rn for the avatar An, to a current unhealthfulness record R′n. The examples for avatar choice 201 in FIG. 2 are only illustrative, as are the corresponding points values 202. In FIG. 2, avatar choices 201 are shown as consumption choices, which is illustrative, and avatar choices 201 may be non-consumption choices.

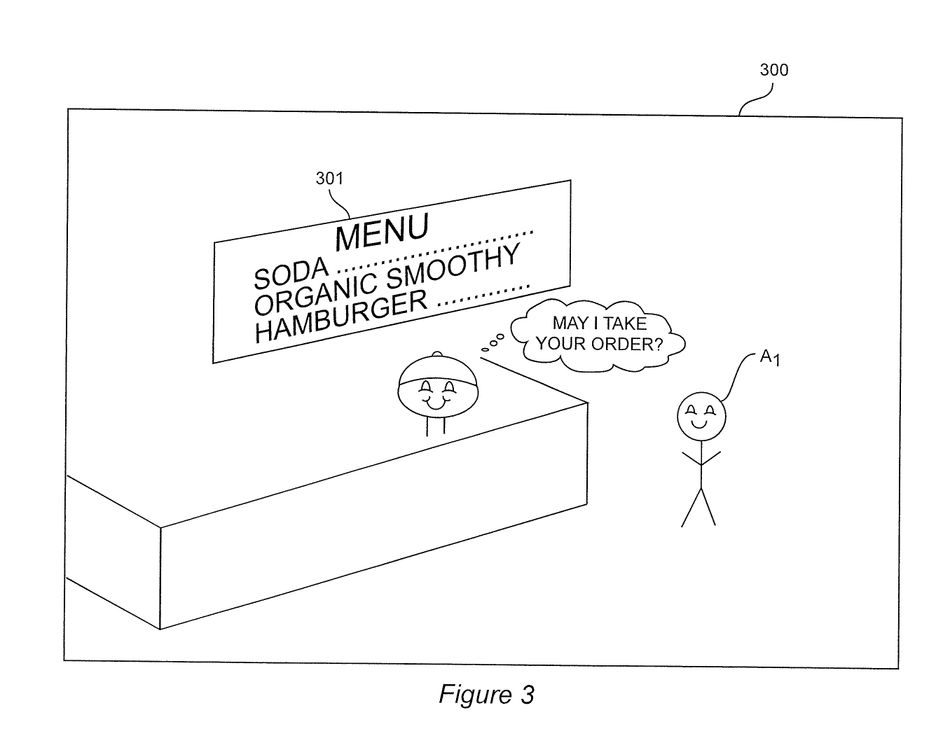

The avatar choices 201 in table 200, such as a choice to consume certain optional consumables 2.001, 2.002, 2.003 available to the avatar correspond to features coded into the virtual world and which the user may select for the avatar optionally to do. For example, the optional consumables 2.001, 2.002 and 2.003 in table 200 preferably are depicted in the virtual world in a visual, life-like representation, such as, in a case where optional consumables 2.001, 2.002 and 2.003 are respectively a soda, an organic fruit smoothy and a hamburger, in a life-like visual display of a menu or menu board 301 (FIG. 3) including words and/or images for soda, fruit smoothy and hamburger which an avatar An such as avatar A1 (FIG. 3) may opt to consume.

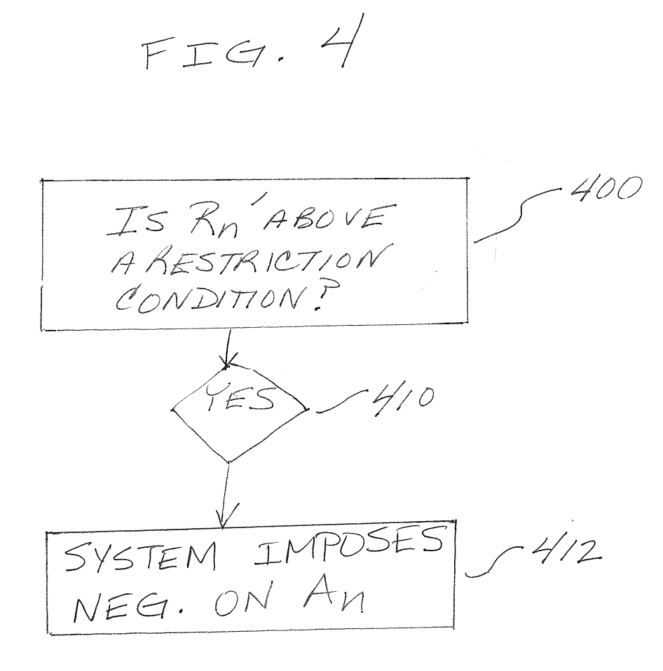

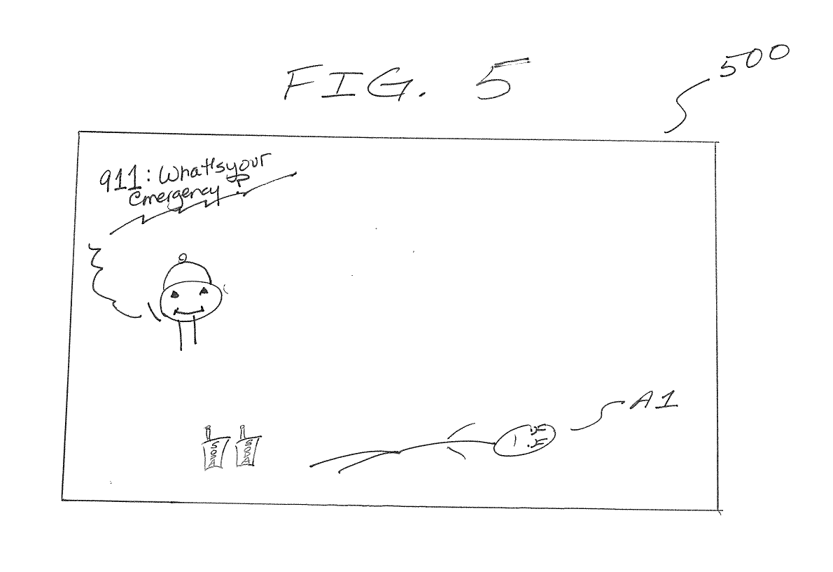

Once the record Rn for an avatar An has been updated to R′n, the updated R′n, which is a numerical quantity, is compared (104) to a certain predefined value maintained by the automated system (which is a restriction condition). As shown further in FIG. 4, the automated system in the comparing step 104 (FIG. 1) determines (400) whether Rn′ is above a restriction, and if Rn′ is found to, YES (410), be above the restriction condition, the automated system operating the virtual world imposes (412) a negative event or consequence on Avatar An corresponding to record Rn'. For example, when the current quantity that is R′n has reached the restriction condition, the automated system executes a step against the avatar An such as, e.g., imposing (412) on the avatar An a heart attack or other negative medical event, and/or other negative consequences. When the automated system imposes (412) a heart attack or other negative medical event on an avatar An due to its updated unhealthfulness record R′n, preferably the imposition step is such that a user controlling the avatar An and/or other users would be likely to logically make a casual link between the choice 201 by the avatar An and the avatar An's having had a heart attack or other negative event. When the automated system imposes (412) a heart attack or other negative medical event or negative consequence on an avatar, preferably the automated system causes a sequence of steps to be performed which correspond to visual images of the negatively-affected avatar (such as avatar A1 in screen 500 in FIG. 5) being seen by at least the user controlling the avatar against which the imposing step 412 is being performed, and optionally also by other users.

Advantageously the invention provides a method for maintaining and processing data for a plurality of avatars in a virtual world, with the processing directed to determining when a heart attack or other negative medical event is to be imposed by the automated system operating the virtual world upon a particular avatar. Advantageously the inventive methods can be used to make users think about possible consequences of certain consumption choices (such as, e.g., food consumption choices, fuel consumption choices, etc.).

In another embodiment, an updatable record Rn that is the subject of the maintaining step 100 (FIG. 1) performed by the automated system operating the virtual world is a body weight value for the avatar An, and the automated system tracks activity of the avatar An (such as, e.g., consumption by the avatar An and exercise by the avatar An) and updates the body weight value for the avatar An based on the activity of the avatar. When the record of the updated body weight value of the avatar An reaches a certain predetermined value, such as a restriction condition, the automated system causes the visual image of the avatar to be modified. For example, an avatar An that has accumulated a certain amount of points from consuming sodas and hamburgers but that has engaged in little or no exercise during a certain period of time may have its visual image changed in a direction of being somewhat heavier-set, with further weight-change of the visual image being only subject to being made by the automated system and not by the user associated with the avatar. Preferably the automated system makes weight-gain changes incrementally. Preferably when the automated system adds weight to an avatar's visual image, the fit of garments worn by the avatar is adjusted in a non-fitting direction such as popped buttons, ripped seams, etc.

In defining a restriction condition, which is a quantity against which updated respective records for a plurality of avatars will be compared, preferably the value assigned to a restriction condition (which will be used by the system to determine whether to impose a restriction upon the avatar) is defined considering the point values 202 that will accrue through avatar choices 201.

Although an inventive virtual world may be operated using a single restriction condition, preferably a plurality of restriction conditions are used for operating the virtual world. To do so, preferably a table of at least one restriction condition is constructed, with each restriction condition in the table expressed in terms of a quantity, namely, a quantity that can be tabulated by the system as a function of one or more activities in which a respective avatar has engaged. For example, if activity of an avatar An is tracked and assessed points according to a table like table 200 (FIG. 2), each restriction condition in the table of restriction conditions is expressed in points. Preferably, points related to food consumption are tracked separately from points related to non-renewable energy usage. In a case corresponding to table 200 (FIG. 2) in which the avatar choices are food consumption choices, an example of multiple restriction conditions in a table is, e.g., a first restriction condition defined at −50 food-consumption points, a second restriction condition defined at −100 food-consumption points, and a third restriction condition defined at −150 food consumption points, and when an avatar An hits −50 points, the automated system changes the visual image of the avatar to add some weight and make its clothes a little tight, when the avatar An hits −100 points, the automated system repeats the weight-adding and clothes-tightening and further imposes a slow-down on the avatar, and when the avatar An hits −150 points, the automated system imposes a heart attack on the avatar An. This is but an illustrative example.

Examples of a restriction that can be imposed on an avatar as performed by an automated system include, e.g., excluding the avatar from accessing certain parts of the virtual world; changing size, changing shape, or otherwise changing an appearance of the avatar with the appearance-change being only updatable by the system operating the virtual world not by the user associated with the avatar; imposing a slow-down on the avatar or otherwise changing a capability of the avatar in a negative direction with the capability-change being only updatable by the system operating the virtual world not by the user associated with the avatar; subjecting the avatar to a heart attack or other negative health event; combinations thereof; etc.

It will be appreciated that a restriction condition, which is a numerical quantity, can be defined for various situations that those constructing (or updating) the automated system that operates the virtual world may find pertinent or may want to influence, such as unhealthy consumption of food; unhealthy consumption of alcohol; obesity; DWI; usage of non-renewable energy; etc.

Optional but preferable features of a virtual world used in the invention are as follows. Preferably, the virtual world includes at least one piece of real estate that is sponsored by a real-world business.

A preferred step when operating a virtual world according to the invention is to include operating a framework in which a plurality of avatars have dating, friendship and/or professional networking and/or other social interactions therebetween.

Optionally, the automated system operating the virtual world may permit each user to set definitions of which other avatars and their associated users will be permitted to see the user's avatar.

Preferably, the invention is practiced with a step wherein the automated system operating the virtual worlds receives a real-world photograph from the user to be associated with the avatar in the virtual world.

Preferably, a virtual world includes at least one virtual business which offers for purchase at least one purchasable product or service that is offered for purchase by an avatar and that, when purchased by the avatar in the virtual world, the automated system operating the virtual world processes the avatar's purchase so that what has been purchased by the avatar is actually delivered in the real world. Such an avatar-shopping feature may be incorporated in, e.g., a virtual world operated with or without use of restriction conditions; a virtual world operated with or without maintenance of unhealthfulness records; an existing virtual world; etc.

The invention may be appreciated by the following examples, without the invention being limited thereto.

### Example 1

### A Virtual World

This inventive example is interactive, web-based and operates in real-time. Innovations are combined to provide users of the website a positive experience, across a range of ages, nationalities, ethnicity, language, and race of users.

This example uses a stand-alone website on the Internet with its own domain name, accessible by users over the Internet. Optionally the website can be accessed by following a hyperlink. For maximizing the number of users, more than one access option can be in use simultaneously.

The virtual world preferably includes a storefront that is visitable by users (such as visitable by an avatar controlled by a user), wherein the storefront depicted in the virtual world may or may not correspond to a real-world business. When a storefront is used, preferably there is also practiced a step in which is performed tracking traffic of users to the storefront including tabulating number of visits by users and number of coupons obtained by users.

Below where we refer to “visitors”, we also mean a “visitor” singly.

### Example 1A

We call this example “Organic Living”, which may be a web-based, virtual-world game or a software application, having the dual purpose of entertaining and educating its audience.

The game in this example is a cyber-representation of a real world scenario in which a family, a couple, or group of friends or an individual go on holiday or vacation at a resort or theme park. In this resort, these individuals engage in all the fun activities as would be expected but for each of those activities, the individual will have a choice to make among healthy/organic lifestyle options, “normal” lifestyle or a lifestyle that may be detrimental to their health or the environment. For example, when the family eats in a restaurant, they can order meals with all organic ingredients or “normal” ingredients. Even if they are ordering from “normal” ingredients, they can order vegetarian or a low-calories seafood diet, or steak or hamburger. Based on choices made, the player accumulates points. The more the players play the game, they accumulate more points. Then, the players are entitled to real and tangible benefits from the website's sponsors. Options such as a vacation get-away package, airline tickets, or coupons to a restaurant or clothing discounts might be the selection earned by the players.

Key features of the game in this example are as follows.

### Example 1B

### A Well-Organized Resort

Like any popular resort or a theme park (like Disneyland), the various components of the resort and the activities are well organized and laid out. The game includes a colorful, well-planned visually appealing guide map of the resort as the launch page, with the guide map being like the guide map received at a resort like Club Med, a theme park like Six Flags, or Epcot Center. All the planned activities for that particular day are published in a tabular format, similar to what is received on a cruise line like Carnival or at a cultural resort like Colonial Williamsburg.

When the user places his cursor over a certain section of the guide map, the name of the activity is shown. If the user right clicks on that component, details or features of that activity are shown. If the user left clicks on that component, the user progress to engage in that activity.

For example, if a user places the cursor on the picture of a Giant Wheel, “Giant Wheel” or a complete name like “The Great OrgLiv Giant Wheel” is displayed. If the user right clicks on the picture, the price per ride is shown along with other detailed facts like whether the next ride is powered by hydrocarbon-based fuels and when the next solar-powered/renewal-energy sourced power will be available. Based on this information, the user can double left click on that Giant Wheel and enjoy the ride or choose to do something else and come back to the renewable-energy powered ride.

The choice of going on the Giant Wheel now or waiting for a few minutes to go on a renewal-energy powered ride, epitomizes a philosophy to be imbued in the mind of the players, especially, impressionable younger players from age 6 to 25. The choice between going on a hydrocarbon-based ride versus a renewable energy-based ride, may mean compromising in terms of time (such as, e.g., a longer waiting period for a renewable-energy based ride), money (e.g., renewable-energy based ride may be more expensive), or getting more points (e.g., the players making the “right” choices as defined by the website operator are rewarded with extra points).

### Example 1C

### Marketplace

The marketplace is a cyber representation of a real-world marketplace including merchants such as grocery stores, department stores, financial institutions, and restaurants. In addition, some hotels can be in the general marketplace area.

The marketplace is an important feature of this example because the individual stores in this cyber-world marketplace are sponsored by their real world representative counterparts, and hence, might even carry the same name. For example, in the marketplace, there preferably is a grocery store specializing in selling organic food. Upon the website operators obtaining an agreement with, e.g., Whole Foods or Trader Joe's, a grocery store in the marketplace would have the same name. Similarly, the hotels in the marketplace may be called, e.g., Marriott or Sheraton, depending on the sponsors. The sponsorship in the marketplace or any other cyber-representation in the game is a revenue generating operation for the game. The companies sponsoring them are afforded an opportunity to advertise and reinforce their brand names, and also ways to sell real world goods or cyber goods.

### Example 1D

### Resort Guides

To help navigate the various sections of the game, the user is provided a choice of three guides: An American guide, a Chinese guide and a South Asian guide. The three guides are strategically chosen to reflect the users from various geographical areas of the world with maximum Internet use and to establish a social rapport and a sense of familiarity with the users.

The resort guide helps the users navigate through the game, and also helps build the brand of the game. Therefore, it is very important that the guides are very carefully designed and should be very likeable and amiable—similar to Mickey Mouse for Disneyland.

To make things as realistic as possible, the resort guides will use a certain vernacular suitable to and consistent with the nationality/race of the guide and that appeals to the audience belonging to that background. Preferably thorough research on the linguistic aspect is done and incorporated in the game design.

### Example 1E

### The Resort

The following attractions are part of the resort in this example: scary rides, horseback riding, hiking (trails), turtle farm, plants of the future (similar to the one shown in Epcot), swimming, beach activity (building a castle, burying in the sand, surfing, getting a tan, beach volleyball), spas, and golf.

### Example 1F

### Workflow—Holistic Centric

In this example, when people come to the resort, they are picked up by buses running on compressed natural gas (CNG). After their arrival at the resort, their identification is checked and depending on the intended duration of their stay, they are granted a visa. The choices are for 3 days, 5 days, 7 days, 1 month, 2 months, 3 months, 6 months, 1 year, 5 years and 15 years. The first-time attendees can stay for a maximum of 7 days. Based on a user's history (number of points accumulated) during the last visit, a user is eligible to stay at the resort for an extended duration.

The point of arrival for all players is the hub where people arrive from faraway places. The hub is where people get processed for their visas and buy their tickets. All first time visitors get the same number of points at no charge.

After the visitors check-in at the hub, they have a choice of either going to an island via a water ride or staying at the resort. All the hotels are either in the resort or on the island. Some of the hotels in the resort are less expensive or more expensive, depending on the amenities they offer. In addition, visitors, based on their energy usage pattern (solar/wind versus non-renewable sources) accumulate points. Hotels using solar or wind energy offer more points.

The visitors who are staying at the resort have to contribute to the growth of the resort in a number of ways, i.e., by helping to create jobs or volunteering their time to the well being of the residents. Based on their contribution, the visitors will accumulate additional points. The more points the visitors accumulate, the more privileges they will earn, such as extending their stay at the resort. Visitors with good records and higher numbers of points are eligible to stay for longer periods beyond six months and can be granted a work visa so they can accumulate more points. Eventually, they can choose to become residents of the resorts and can buy a cottage or other pieces of real estate using their points or actual money or a combination of the two.

Throughout their stay at the resort, the visitors will participate in daily activities that they would normally do when they are on real vacation. The only difference is that the visitors are encouraged to participate in holistic activities through the point system described below.

### Example 1G

### The Point System to Affect People's Behavior

The point system is an important behavior modification methodology that can reinforce certain kinds of behavior and social patterns at the resort. This resort is a cyber representation of utopia with its own rules and forms of governance. In this example, the object of game, from the perspective of the operators of the virtual world, is to attract as many visitors to the resort (i.e., the website) as possible, so that revenues are maximized based on number of ad clicks or sponsorships. However, in this example, the resort is not open for everybody and the resort is operated under the assumption that it is a privilege (not a right) for people to return to the resort. For people engaged in questionable activities and who are short of the requisite number of points, they will have an opportunity to buy additional points (using real money) or receive points from their friends and family. However, that privilege will go only to a certain point—for people who are really short of points will not be able to buy points and may be banished from the resort for a certain period of time or permanently.

### Example 1H

### Types of Activities

Some non-limiting representative examples are as follows.

Restaurants: Just as any tourists will eat out at a restaurant, the visitors to the resort will be presented a number of dining choices. Based on their decisions, the visitors will accumulate or lose points. For example, if the visitors are eating at fast food restaurants and are choosing hamburger, French fries and soda, they will lose points, compared to people having an organic salad and organic carrot juice. Children choosing organic oatmeal with organic non-fat milk or organic soy milk will accumulate higher points than kids choosing to eat cheese omelets with bacon.

Hotels: Visitors are presented a choice of hotels. Those visitors who choose to stay at hotels that follow environmental-friendly practices will accumulate more points.

Rental Cars: Visitors to the resort who take public transportation or rent electric/hybrid cars will accumulate more points than people choosing to rent traditional cars. Visitors choosing gas guzzlers and SUV's will lose points because of the impact on the environment.

Choice of Clothing: At the check-in and after the visitors have cleared the hub, they are given an identity card where they can upload their picture. An animated picture is created based on the photograph. The users will have a choice of clothing to dress their character. If the visitors choose to use organic cotton, they will accumulate more points compared to other types of clothes.

Hunting: This is a representative activity that in this example is well regulated and enforced. Activities like this will have a place on the cyber-resort, however, the participants choosing to engage in activity like this or in similar activities may lose points rapidly if their behavior or practices are harmful (i.e., maiming an animal and not killing it because of poor marksmanship). The participants may acquire points for expert marksmanship and “wild game” donations to soup kitchens and the needy.

Horseback Riding: The visitors will have an opportunity to make an informed decision as to which enterprise they will participate. One of the businesses may advertise itself as friendlier toward animals at the expense of slightly higher prices. Visitors choosing to go to these businesses will accumulate more points. The software implementation is based on research to determine the best practices in this or other types of businesses.

Bowling: Here is an example of seemingly innocuous activity where multiple businesses may operate the same way with similar price structure. However, the choice a visitor to the resort makes in picking a bowling alley may get him or her additional points if they pick a place that offers healthier choices on its menu (supporting holistic lifestyle) as opposed to one that just offers pizza, fries and ice cream. Similar criterion are applied to other establishments such as movie theaters, grocery stores, shopping malls, etc.

### Example 1I

### Social Networking and Visual Representation of Real Life for Visitors

Even though the primary purpose of the resort is to impart to impressionable minds some of the benefits of organic living, ecological and salubrious activities (like Yoga, walking, exercise), in making this game very similar to real life this game also is a powerful tool for developing a social networking site.

In this example, all visitors to the site have an opportunity to upload their picture. The software engine converts the real life picture to an animated picture. The visitors have an opportunity to drag the picture into any activity in which they want to participate. For example, if the visitors are renting a car, they can drag their animated picture and put it in the car. Or if they are going into a disco, they can drag their picture and put it inside. The visitor is able to see other people (each with real animated picture) walking around or dancing in the disco. The user has a choice of what image to show the public—the user can choose to show the animated picture, real picture, or a generic animation (almost like being masked). This transition can be made any time during their visit by right-clicking on their own image and choosing among the three options.

The users also have an opportunity to take their image and modify it a little bit by changing the hair style or in case of men, adding facial hair like moustache or beard. Software tools on the website allow such changes to be made.

For visitors whose gender is made known, they also have a choice of the dresses or attire that they (i.e. their cyber-persona) will wear during their stay or on a particular day. The software allows the visitors to pick and choose the style and fabric of the dresses or other attire. Again, like most activities on the resort, people choosing dresses made of organic cotton will get more points.

### Example 1J

### A Fun Real-Life-Like Experience for the Users Operating the Avatars which are Visitors to a Dance Club)

In this example, the virtual world includes a dance club. The visitors to the club are walking around, dressed in their fashionable costumes that they have chosen to wear. They can see faces (real or animated) of other people visiting the club. At the club, healthy drinks (organic fruit smoothies), organic juices and sodas are served. People (over 21) have a choice of buying alcoholic drinks but that choice will depreciate their points based on the type and number of drinkers. Drinkers of organic smoothies will get the maximum points.

At the virtual-world dance club, adults have an opportunity to meet other adults, just like in real life. The visitors can play to visit the club along with their friends by marking their scheduler/planner and sending an invite to their friends. If a user likes someone at the club, the user's avatar can make a request to chat with them; the recipient has a chance to accept or turn down the request. Visitors can also choose to leave the club, become masked (i.e. use a generic face) or mark as ‘do not disturb’.

In this example, the invention provides a comprehensive unified real-life-like scenario that not only promotes a healthy life style but also is like a virtual reality version of the real-world.

In this example, no obscenity or objectionable material is allowed on the website.

### Example 1K

### Game

This example includes the following features of an inventive game, virtual-world or website.

A Virtual Reality for Real Life Activities: A comprehensive plan is provided for a virtual reality snapshot of numerous life-like activities under one integrated platform.

An Organic and Holistic Lifestyle: This example improves upon conventional isolated attempts to motivate kids with farming activities or healthy eating habits. This is a comprehensive platform that encompasses a wide range of activities such as travel/tourism, life style (fashion, dressing), eating (choices of healthy versus junk food/fast food), entertainment (cyber-representation of dance clubs/disco), social networking (with visual representation, allowing strangers and friends to meet at public places like restaurants, streets, dance clubs, gymnasium, yoga studio, dance classes, and even doctors).

A Point System of Rewards: This example includes a mechanism for rewarding visitors to the site where they will get additional points by choosing good activities. The point system can be used to penalize young adults (under 18) for using too much profanity or anyone attempting to buy alcohol. In an optional additional bait system, law enforcement personnel dress up as other visitors and offer to buy people alcohol or drugs. If visitors fall for the trap, they are fined and given a warning. If after three warnings, they still exhibit the same behavior, they are ejected from the site and blocked from entering again (at least using the same ID), even if they attempt to pay using real money or get points from their friends. The system is designed to penalize friends who vouch for violating participants who become repeat offenders.

This system of earning points and the inability to re-renter the resort even if the visitor agrees to spend money is an important feature. Important social-ties (peer pressure) that can help shape behavior are embedded in the possibility of penalties for the friends who seek to save the participating status of a peer. This system not only carries the message that the game's operators stand behind certain principles, but also allows the website to become a totally commercial profit-making operation, based in part on personal connection between people.

A Visual Social Network Representing Real Life Experience: Just as in real life, people develop healthy relationships by following common activities where they can see and communicate with other people, and just as in schools, colleges, and places of work, people develop friendship by getting to know other people's behaviors, habits, and their responses to challenges, similarly, in this example, the game offers an overall encompassing umbrella under which many social activities take place. This allows plenty of opportunities for friends to participate in activities together but also to be able to make friends/acquaintances with other strangers. The point system ensures that visitors do not let the game deteriorate to a level that deviates from a primary purpose underlying the game—to drive people toward good, healthy habits in the cyberspace, which the inventors believe will eventually have an impact on real life.

This example includes a visual representation of visitors with their actual faces or animated pictures. This example also includes the ability to participate in fun activities like dancing, where the user can see the actual images (animated or pictures) of the user's friends and other people (including strangers). From a social networking perspective, visitors to the site are able to judge each other based on their looks, dressing style (of which the visitors have control), and types of activities participated-in. A life-like representation of how people meet in the real world is provided.

Noble Goal and Educational Impact: This game offers a platform to impart knowledge of life's important lessons to people (especially young people and young adults) in a visually appealing platform where visitors learn by interacting with friends and strangers and are driven towards generally healthy/good habits by a carrot-and-stick system of points.

In this example, knowledge and research from various fields (such as health science, medicine, food and nutrition sciences, etc.) are distilled into key principles and formulated in an entertaining life-like virtual reality platform.

In this example, over-commercialization of the platform is avoided. This example is based on transparency and commitment to a “noble” goal of making people happy and healthy, to attract people to the website.

Comprehensive Umbrella: Multiple activities (like dance studio, yoga classes, travel/tourism, dressing a character with choice of clothes) are on one website, in one virtual world, with an overall binding theme of organic holistic living with a strong visual appeal and an optimum blend of educational purpose and entertainment. The game is easy to understand, and is based on wide knowledge spanning areas such as health, education, entertainment, clothing, lifestyles under one platform.

### Example 2

In this inventive example, when the user does something (such as buys something) in the real world, the user is able to get credit in the virtual world. Such incentives can be linked to a loyalty-based program like a frequent shopper's program, frequent fliers program, etc.

### Example 2A

In this example, when the parents buy $50 worth of groceries at a real-world organic supermarket, they get credit for 5 points for their child's avatar in the virtual world.

### Example 2B

In this example, a user donates to a non-profit organization or an NGO that supports community development or quality of human life for people in countries in Africa or Asia, or in a specific developing country, or that supports research for diseases such as cancer or Alzheimer's disease, and is therefore able to get points (as an incentive) in the virtual world.

### Example 3

In this example, when a user does community service (in the real world or virtual world), the user gets positive points in the virtual world.

It should be appreciated that variations and modifications from the embodiments set forth above may be made without departing from the spirit of the invention, and that such modifications are to be considered within the present invention.

1-18. (canceled)

19. A method of receiving and filling purchase orders, comprising steps, performed by a computing device, of:
constructing a virtual world including at least one virtual business which offers for purchase at least one purchasable product or service that is offered for purchase by an avatar in the virtual world and that when purchased by an avatar in the virtual world is delivered outside the virtual world, in a real world delivery; and
via the virtual business, receiving a purchase order by an avatar;
processing the avatar's purchase order and causing the real world delivery.

20. The method of claim 19, including causing the real-world shipment and delivery of real-world goods.

21. The method of claim 19, including causing the real-world provision of real-world services.

22. A method of receiving and filling purchase orders, comprising steps, performed by a computing device, of:
operating a virtual world including at least one virtual business which offers for purchase at least one purchasable product or service that is offered for purchase by an avatar in the virtual world and that when purchased by an avatar in the virtual world is delivered outside the virtual world, in a real world delivery; and
via the virtual business, receiving a purchase order by an avatar;
before filling the purchase order by the avatar, screening for a health status or other non-financial status of the avatar in records maintained by the system based on the avatar's activity in the virtual world.

23. The method of claim 22, including denying the avatar purchasing privileges as a function of the avatar having met a certain restriction condition, the certain restriction condition being non-financial.

24. The method of claim 22, including denial of purchasing privileges to an avatar who had a recent heart attack or other health problem in the virtual world.

25. The method of claim 22, including, after screening the health status or other non-financial status of the avatar, rewarding the avatar with a real-world discount or other reward having real-world value.

26. The method of claim 22, including permitting each user to set definitions of which other avatars and their associated users will be permitted to see his avatar.

27. The method of claim 22, wherein an avatar optionally has a voice.

28. A method of operating a virtual world, comprising steps, performed by a computing device, of:
issuing a credit card to an avatar with a certain credit limit, wherein the credit card is useable by the avatar to accomplish a real-world transaction.

29. A method of operating a virtual world useable simultaneously by a plurality of users, each user controlling a respective avatar, comprising steps, performed by a computing device, of:
maintaining a table comprising at least one restriction condition, wherein each restriction condition is expressed in terms of a quantity and the quantity is tabulated by the system as a function of one or more activities in which the avatar has engaged and which are defined by the system as, when performed by an avatar, having a certain predefined contribution to the quantity being tabulated for a certain restriction condition;
for each avatar, maintaining an updatable record for each restriction condition;
for at least one activity in which avatars may engage and which is linked to a restriction condition, tracking whether an avatar engaged in that activity, and if so, updating the updatable record for the avatar;
screening for whether an avatar has met a certain restriction condition;
for an avatar that has met the certain restriction condition, restricting the avatar according to a restriction for the certain restriction condition.

30. The method of claim 29, wherein the restriction is selected from the group consisting of:
excluding the avatar from accessing certain parts of the virtual world;
changing an appearance of the avatar with the appearance-change being only updatable by the system operating the virtual world not by the user associated with the avatar;
changing a capability of the avatar in a negative direction with the capability-change being only updatable by the system operating the virtual world not by the user associated with the avatar;
subjecting the avatar to a heart attack or other negative health event;
involuntary logging-off the avatar and the user associated therewith;
blocking the user associated with the avatar from logging-in; and
combinations thereof.

31. The method of claim 29, in which the restriction condition is selected from the group consisting of
a condition that is a definition of an avatar controlled by the user having engaged in an unhealthy consumption of food or alcohol, and upon finding that a user has met the condition, performing a restriction for the user;
an anti-obesity condition that is a definition of an avatar controlled by the user in the virtual world consuming more than a certain amount of calories within a certain period of time;
a DWI condition that is a definition of an avatar controlled by a user in the virtual world attempting to operate a vehicle after having consumed more than a certain quantity of alcohol within a certain recent time period.

32. The method of claim 29, including storing for each avatar an updatable record for each restriction condition that indicates a quantity attributed to the avatar that is comparable to the quantity of the restriction condition.

33. The method of claim 29, wherein an avatar has a current appearance, and upon the avatar being found to have met a certain defined restriction condition, the system operating the virtual world alters the current appearance to a changed appearance.

34. The method of claim 29, including receiving an initial indication of body weight from a user for characterizing the avatar controlled by the user;
maintaining a body weight value for the avatar as an updatable record;
tracking activity of the avatar and updating the updatable body weight value for the avatar based on activity of the avatar.

35. The method of claim 29, including receiving a real-world photograph from the user to be associated with the avatar in the virtual world.

36. The method of claim 29, including meanwhile permitting the user to manipulate certain features of the appearance of the avatar.

37-46. (canceled)
